(19) United States
(12) Patent Application Publication
(10) Pub. No.: US 2010/0124352 A1
(43) Pub. Date: May 20, 2010

(54) MICRO MAGNETIC DEVICE WITH MAGNETIC SPRING

(75) Inventors: Insik Jin, Eagan, MN (US); Dadi Setiadi, Edina, MN (US); Yong Lu, Rosemount, MN (US); Jun Zheng, Edina, MN (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/270,966

(22) Filed: Nov. 14, 2008

(51) Int. Cl. H04R 1/00

(52) U.S. Cl. 381/396

(57) ABSTRACT

A micro magnetic device having a body defining at least part of an enclosed chamber, the body comprising a first sidewall and a second sidewall. A pole comprising a soft magnetic material is within the chamber and an electrically conductive coil is positioned around the pole. A diaphragm is connected to the first sidewall and a permanent dipole magnet is connected to the second sidewall at a first end and to the diaphragm at a second end. The dipole magnet is offset centrally from the pole. The diaphragm may also be offset centrally from the first pole. The micro magnetic device may be made by MEMS or thin film techniques.

### BACKGROUND

Speakers are acoustical elements that are common is today's society. Speakers are present in radios, stereo systems, televisions, computers, earphones/headphones and other personal equipment that is configured to emit sound. Without speakers, one could not enjoy music, a television program, or a movie, to its full extent.

A traditional speaker (also referred to as a loud speaker or variation thereof) has a large magnet in close proximity to a movable current coil which drives a cone/diaphragm. The oscillating cone/diaphragm generates sound. A single loud speaker, however, typically does not have sufficient frequency bandwidth to amplify an audio signal at the full bandwidth. To expand the overall bandwidth of a speaker system, a multi-speaker system is compiled where each speaker is responsible for a limited bandwidth range. This type of system consumes a large amount of power, occupies larger space and is expensive. This issue also exists in headphones or earphones products.

Attempts have been made to miniaturize speakers using micro-system technology (MST). Although low cost and good reproducibility of electronic circuitry has been obtained, the number of realized loudspeakers using MST is small and these loudspeakers generally do not fulfill the requirements for a hearing instrument such as headphone or earphones. Better micro-speakers and methods of making them are needed.

### BRIEF SUMMARY

The present disclosure is directed to micro magnetic devices (e.g., micro-speakers) suitable for use with a broadband acoustic range. The micro magnetic devices can be made by batch microfabrication processing using thin film or micro-electromechanical system (MEMS) techniques. A plurality of the monolithic elements can be provided as an array to provide a broader bandwidth of acoustic range.

In one exemplary embodiment, this disclosure provides a micro magnetic device having a body defining at least part of an enclosed chamber, the body comprising a first sidewall and a second sidewall. A pole comprising a soft magnetic material is within the chamber and an electrically conductive coil is positioned around the pole. A diaphragm is connected to the first sidewall and a permanent dipole magnet is connected to the second sidewall at a first end and to the diaphragm at a second end. The dipole magnet is offset centrally from the pole. The diaphragm may also be offset centrally from the first pole.

These and various other features and advantages will be apparent from a reading of the following detailed description.

### BRIEF DESCRIPTION OF THE DRAWING

The invention may be more completely understood in consideration of the following detailed description of various embodiments of the invention in connection with the accompanying drawing, in which:

FIG. 1 is a schematic cross-sectional view of a micro magnetic speaker device;

FIG. 2 is a schematic cross-sectional view of a first embodiment of a micro magnetic speaker device according to this disclosure; FIG. 2A is an alternate schematic cross-sectional view of the micro magnetic speaker device of FIG. 2;

FIG. 3 is a schematic cross-sectional view of a second embodiment of a micro magnetic speaker device according to this disclosure;

FIG. 4 is a schematic cross-sectional view of a third embodiment of a micro magnetic speaker device according to this disclosure;

FIG. 5 is a schematic top view of an array of micro magnetic devices according to this disclosure;

FIG. 6 is a graphical representations of peak frequency/bandwidth versus amplitude for multiple micro-speakers according to this disclosure;

FIGS. 7A-7C are schematic cross-sectional views of a process for making a first half of a micro magnetic device;

FIGS. 8A-8D are schematic cross-sectional views of a process for making a second half of a micro magnetic device; and

FIGS. 9A and 9B are schematic cross-sectional views of a process for combining the first half of FIGS. 7A-7C with the second half of FIGS. 8A-8D to form a micro magnetic device.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present invention. The following detailed description, therefore, is not to be taken in a limiting sense.

The present invention is directed to miniaturized, micro magnetic devices such as micro-speakers. The elements can be used in high performance speaker devices, such as headphone or earphone devices, or in acoustic signal detection devices. The applications for the micro magnetic devices are not limited to entertainment or other audible uses, but can also include applications above that audible by humans (i.e., above about 20 kHz) such as military, biomedical and marine uses.

The micro magnetic devices of this invention are built on a single semiconductor chip using micro magnetic actuator technology (e.g., thin film or micro-electro-mechanical (MEMS) techniques). An array of micro magnetic devices can be built on a single chip. In an array, each micro element covers a predefined bandwidth based on its unique physical and mechanical structure. A combination of a plurality of micro elements can offer broad bandwidth coverage for any audio signal which is delivered or received.

For example, a micro magnetic device or speaker of this disclosure may have a body defining at least part of a first enclosed chamber, the body comprising a first sidewall and a second sidewall. A first pole comprising a soft magnetic material is within the first chamber and a first electrically conductive coil is positioned around the first pole. A diaphragm is connected to the first sidewall and a permanent dipole magnet is connected to the second sidewall at a first end and to the diaphragm at a second end. The dipole magnet is offset centrally from the pole. The diaphragm may also be offset centrally from the first pole. Such a micro magnetic device may have two chambers, each having a pole and a coil therearound.

As another example, a micro magnetic device or speaker of this disclosure may have a first enclosed chamber having therein a first pole comprising a soft magnetic material and a first electrically conductive coil positioned around the first pole, and a second enclosed chamber having therein a second pole comprising a soft magnetic material and a second electrically conductive coil positioned around the second pole. The first chamber and the second chamber can share a first sidewall and a second sidewall. A diaphragm is connected to the first sidewall and a permanent dipole magnet is connected to the second sidewall at a first end and to the diaphragm at a second end. The dipole magnet is offset centrally from the pole. The diaphragm may also be offset centrally from the first pole.

As yet another example, a micro magnetic device or speaker of this disclosure may have a first enclosed chamber having therein a first pole comprising a soft magnetic material and a first electrically conductive coil positioned around the first pole, and a second enclosed chamber having therein a second pole comprising a soft magnetic material and a second electrically conductive coil positioned around the second pole. A diaphragm and a permanent dipole magnet extend between the first chamber and the second chamber and are oscillatable into and out from the first chamber and the second chamber based on a magnetic spring constant. The diaphragm and permanent dipole magnet may also be oscillatable into and out from the first chamber and the second chamber based on a mechanical spring constant.

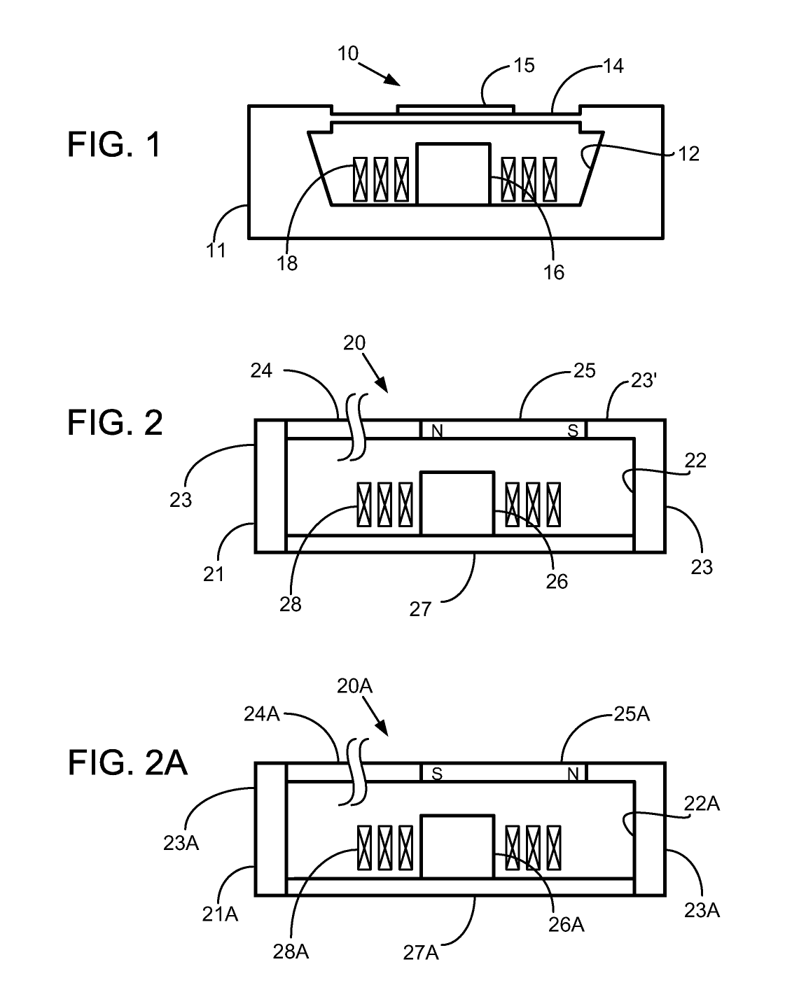

While the present invention is not so limited, an appreciation of various aspects of the invention will be gained through the discussion provided below. A general embodiment of a micro magnetic device is illustrated in FIG. 1 as micro-speaker 10. It should be understood that although the following discussion will be directed to a micro-speaker, the micro magnetic device could alternately be a micro sensor or the like.

The micro magnetic device micro-speaker 10 has a body 11 that forms the overall shape of micro-speaker 10. FIG. 1 is a side view of micro-speaker 10, from a top view, micro-speaker 10 may be circular or rectangular (e.g., square), although in most embodiments, is circular.

In most embodiments, micro-speaker 10 and other micro magnetic devices of this disclosure, such as those described below, are no more than about 10 mm, in some embodiments, about 5 to 10 mm in their largest dimension. For a circular micro magnetic device, the largest dimension is usually the diameter across body 11. In other embodiments, micro magnetic devices of this invention have a largest dimension of no more than about 4 mm, in some embodiments about 2 to 4 mm, and often, about 1 mm in largest dimension.

Body 11 may be a dielectric material (for example, a polyamide or polyimide material), a metal, or other semiconductor or chip material. Silicon (Si) is a common material for body 11. Body 11 at least partially defines an enclosed inner chamber 12. Chamber 12 is defined by body 11 and a diaphragm 14 extending across chamber 12. Diaphragm 14 is integral with body 11, in that diaphragm 14 is an extension of body 11 and is formed from the same material as body 11.

Present proximate diaphragm 14 is a magnetic thin film 15. Magnetic thin film 15 is a hard or permanent magnet, the magnetization orientation of which does not change. Examples of permanent magnet materials include iron (Fe), chromium (Cr), cobalt (Co), nickel (Ni), platinum (Pt), vanadium (V), manganese (Mn), bismuth (Bi), and combinations thereof. Magnetic thin film 15 may be made of bulk material or may be electrochemical deposited (e.g., plated). In most embodiments, magnetic thin film 15 is about 1 to 200 micrometers thick, and may be thicker or thinner than diaphragm 14 which supports it. In some embodiments, magnetic thin film 15 is about 1 to 100 micrometers thick.

During use of speaker 10, the suspended combination of diaphragm 14 and magnetic thin film 15 oscillates in a vertical direction, toward and away from chamber 12, at a frequency to produce sound waves. Through different designs of diaphragm 16, the bandwidth of micro-speaker 10 can be adjusted for a desired frequency range. The peak frequency (fₚₑₐₖ) for micro-speaker 10 is dependent on the thickness of diaphragm 16, the width of diaphragm 16, and also the Young's Modulus of diaphragm 16. Thus, the physical design of diaphragm 14 affects the bandwidth and peak frequency of speaker 10.

Diaphragm 16, which oscillates, is fairly thin, typically about 1 to 100 micrometers thick, and in most embodiments, has a diameter of about 0.5 to 2 mm. In some embodiments, including that illustrated in FIG. 1, diaphragm 14 does not extend across the entire width of chamber 12, but rather, a portion of body 11 extends over chamber 12 and transitions into diaphragm 14.

Positioned within chamber 12 is a pole 16 of a soft magnetic material with high momentum, the magnetization of which can be altered by being exposed to a magnetic field. Examples of soft magnetic materials include ferromagnetic materials such as nickel (Ni), iron (Fe), cobalt (Co), iron oxide (Fe₂O₃), and combinations thereof. In this illustrated embodiment, pole 16 is present on an interior surface of inner chamber 12; in alternate embodiments, pole 16 may be recessed into body 11, i.e., the lower edge of pole 16 is below the lower wall of chamber 12.

An electrically conducting coil 18 is positioned around pole 16. Coil 18 is formed from an electrically conducting material, typically metal. Examples of suitable metals for coil 18 include copper (Cu), aluminum (Al), silver (Ag) and gold (Au). In FIG. 1, coil 18 is illustrated being a single layer with three turns; other designs for a coil may be useful, such as more or less turns, or multiple layers. Coil 18 may have, for example, from one to 100 (one hundred) turns around pole 16.

In use, an electrical current is applied to coil 18. The current in coil 18 will generate a magnetic field and polarize (e.g., charge) soft magnetic pole 16. The total magnetic field from pole 16 will produce an attraction or repelling force on magnetic thin film 15, which will drive diaphragm 14 toward and away from pole 16 (e.g., down and up), thereby creating waves (e.g., sound waves).

Other configurations of micro magnetic devices, e.g., speakers, are illustrated in FIGS. 2 and 2A and FIGS. 3 and 4. The various elements of the following micro magnetic devices as similar to the respective elements of micro-speaker 10, described above, unless otherwise indicated.

FIG. 2 illustrates a micro-speaker 20 having a body 21 that forms the overall shape of micro-speaker 20. FIG. 2 is a side view of micro-speaker 20; from a top view, micro-speaker 20 may be circular or rectangular (e.g., square), although in most embodiments, micro-speaker 20 is circular. Body 21 includes sidewall non-magnetic portions 23 and a magnetic portion 27 extending between sidewall non-magnetic portions 23. In this embodiment, a beam portion 23′ of sidewall non-magnetic portions 23 extends out from the sidewall. An enclosed inner chamber 22 is defined by body 21 (i.e., by non-magnetic portions 23 and magnetic portion 27), a diaphragm 24 and a magnetic member 25, which are connected together. Each of diaphragm 24 and magnetic member 25 is connected to non-magnetic sidewall portions 23, and are also connected together.

Unlike body 11 of micro-speaker 10 of FIG. 1, body 21 is formed from at least two different materials, a non-magnetic material for non-magnetic portions 23 and soft magnetic material for magnetic portion 27. Examples of suitable materials for non-magnetic portions 23 include dielectric materials (for example, a polyamide or polyimide material), non-magnetic metal, and semiconductor or chip material. Silicon (Si) is a common material for non-magnetic portions 23. In micro-speaker 20, two non-magnetic portions 23 are present; these two portions 23 may be made from the same or different non-magnetic material. Soft magnetic portion 27 has a high momentum, the magnetization of which can be altered by being exposed to a magnetic field. Examples of suitable materials for soft magnetic portion 27 include ferromagnetic materials such as nickel (Ni), iron (Fe), cobalt (Co), iron oxide (Fe₂O₃), and combinations thereof.

Diaphragm 24 is formed from a flexible material, one that can readily oscillate. Examples of suitable materials for diaphragm 24 include silicon (Si), polyimides, polyamides, and metallic foils, such as foils of NiCr, Al, W, Nb and Ta. In some embodiments, diaphragm 24 may be formed from the same material as non-magnetic portion 23 of body 21, whereas in other embodiments, diaphragm 24 is a material different that for non-magnetic portion 23. In most embodiments, diaphragm 24 is about 1 to 200 micrometers thick, often about 50 to 100 micrometers thick. Diaphragm 24 is offset from the center of chamber 22, in that it is not centrally or symmetrically positioned over the speaker pole and coil (described below). In some embodiments, diaphragm 24 may extend over all or a portion of the pole, but does not center itself over the pole.

Magnetic member 25 also is offset from the center of chamber 22, in that it is not centrally or symmetrically positioned over the speaker pole and coil (described below). In some embodiments, magnetic member 25 may extend over all or a portion of the pole, but does not center itself over the pole. Magnetic member 25 is a hard or permanent magnet, the magnetization orientation of which does not change. Examples of permanent magnet materials include iron (Fe), chromium (Cr), cobalt (Co), nickel (Ni), platinum (Pt), vanadium (V), manganese (Mn), bismuth (Bi), and combinations thereof. In most embodiments, magnetic member 25 is about 1 to 200 micrometers thick, often about 50 to 100 micrometers thick. In the illustrated embodiment, magnetic member 25 has the same or similar thickness as diaphragm 24. In FIG. 2, magnetic member 25 is a dipole magnet, positioned with its south pole attached to body 21 at non-magnetic portion 23 and with its north pole connected to diaphragm 24.

Positioned within chamber 22 is a pole 26 made of soft magnetic material with high momentum, the magnetization of which can be altered by being exposed to a magnetic field. Examples of soft magnetic materials include ferromagnetic materials such as nickel (Ni), iron (Fe), cobalt (Co), iron oxide (Fe₂O₃), and combinations thereof. In this illustrated embodiment, pole 26 is present on an interior surface of inner chamber 22; in alternate embodiments, pole 26 may be integral with body 21, e.g., with soft magnetic portion 27. With pole 26 positioned proximate or on magnetic portion 27, magnetic portion 27 functions as a return pole for micro-speaker 20.

An electrically conducting coil 28 is around centrally positioned pole 26. Coil 28 is formed from an electrically conducting material, typically metal. Examples of suitable metals for coil 28 include copper (Cu), aluminum (Al), silver (Ag) and gold (Au). Coil 28 is electrically connected to a circuit (not shown) that provides electric current to coil 28.

In use, an electrical current is applied to coil 28, which generates a magnetic field and polarizes (e.g., charges) pole 26 and optionally magnetic portion 27. The total magnetic field from pole 26 and portion 27 produces an attractive or repelling force on magnetic material 25, driving magnetic material 25 toward and away from pole 26 (e.g., down and up) in an oscillating motion. Because the south end of magnetic material 25 is fixed to non-magnetic material sidewall 23, the north end of magnetic material 25 oscillates toward and away from pole 26. Diaphragm 24, connected to magnetic member 25 at an end, likewise oscillates, toward and away from chamber 22, at a frequency to produce sound waves. Both non-magnetic material 23 and diaphragm 24 have a spring constant, which affects the oscillation of magnetic member 25; diaphragm 24 generally has a lower spring constant than non-magnetic material 23, allowing more movement proximate diaphragm 24 than proximate non-magnetic material 23. Magnetic member 25 and diaphragm 24 may oscillate up (e.g., away from pole 26) the same distance as it oscillates down (e.g., toward pole 26), or may move away from less than is moves toward pole 26. Although magnetic member 25 is a dipole, as mentioned above, during oscillation it functions as a monopole, due to only one end (i.e., the end proximate diaphragm 24) being readily able to oscillate and the other end (i.e., the end proximate non-magnetic material 23) being fixed.

Through different designs of diaphragm 24 (e.g., thickness, length, etc.), the bandwidth of micro-speaker 20 can be adjusted for a desired frequency range. The peak frequency (fₚₑₐₖ) for micro-speaker 20 is dependent on the thickness of diaphragm 24, the width of diaphragm 24, and also the Young's Modulus of diaphragm 24. Thus, the physical design of diaphragm 24 affects the bandwidth and peak frequency of speaker 20. Additionally, the physical design of magnetic member 25 (e.g., thickness, width, and material) affects the performance of speaker 20. In the embodiment illustrated in FIG. 2, the north pole of magnetic member 25 is positioned at a far edge of pole 26; in alternate embodiments, magnetic member 25 may extend past pole 27 or may not extend across the width of pole 26. Still further, non-magnetic material 23 and the physical connection between magnetic member 25 and non-magnetic material 23 (in this embodiment, at the south pole of magnetic member 25) affect the performance of speaker, by at least partially defining the properties of chamber 22 and the position of magnetic member 25. The configuration of non-magnetic material 23, where it is connected to magnetic member 25, also affects the performance of micro-speaker 20. The spring constant of non-magnetic member 23 can be adjusted by changing the physical design of non-magnetic member 23, thus affecting the oscillation of magnetic member 25 and thus the bandwidth and peak frequency of micro-speaker 20. These various elements allow micro-speaker 20 to be tuned to a desired bandwidth and/or peak frequency. Each of these tunable elements, for micro-speaker, is a physical or mechanical element.

A variation of micro-speaker 20 is illustrated in FIG. 2A as micro-speaker 20A. The various elements of micro-speaker 20A are the same as for micro-speaker 20, unless indicated otherwise.

Micro-speaker 20A has a body 21A that forms the overall shape of micro-speaker 20A. Body 21A includes two non-magnetic portions 23A and soft magnetic portion 27A. An enclosed inner chamber 22A is defined by body 21A, a diaphragm 24A and a magnetic member 25A, which are connected together. In FIG. 2A, magnetic member 25A is positioned with its north pole attached to body 21A at non-magnetic portion 23A and with its south pole connected to diaphragm 24A. Positioned within chamber 22A is a pole 26A of a soft magnetic material with an electrically conducting coil 28A therearound. In use, because the north end of magnetic material 25A is fixed, the south end of magnetic material 25A oscillates toward and away from pole 26A.

Micro-speakers 20, 20A described above have a single chamber with the pole and coil positioned on one side of the oscillating diaphragm and magnetic member. The bandwidth and peak frequency of speakers 20, 20A are generally dependant on mechanical features of the speaker, e.g., the spring constants of non-magnetic material 23 and diaphragm 24, configuration of diaphragm 24, and configuration of magnetic member 25. Micro-speakers having multiple chambers may also be design, with a chamber with a pole and coil positioned on each side of the diaphragm and the magnetic member.

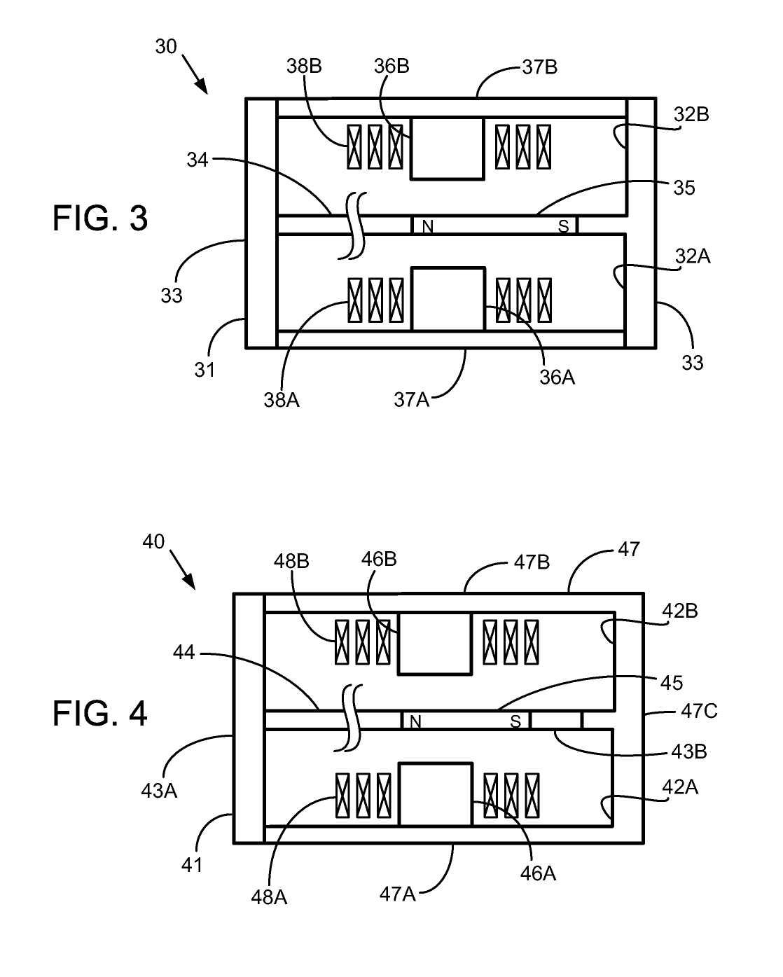

FIG. 3 illustrates a multi-chambered micro-speaker 30 having a body 31 that forms the overall shape of micro-speaker 30, which in this embodiment, can be generalized as a micro-speaker with two chambers, or, as two micro-speakers sharing one diaphragm. Body 31 includes two opposite sidewall non-magnetic portions 33 separated by two magnetic portions 37A and 37B extending between non-magnetic portions 33. A first enclosed inner chamber 32A is defined by non-magnetic portions 33, magnetic portion 37A, a diaphragm 34 and a magnetic member 35, which are connected together. A second enclosed inner chamber 32B is defined by non-magnetic portions 33, magnetic portion 37B, diaphragm 34 and magnetic member 35. Magnetic member 35 is fixedly attached to non-magnetic sidewall member 33 at a first end (at its south pole in FIG. 3) and to diagraph 34 at a second end (at its north pole in FIG. 3).

Positioned within chamber 32A is a pole 36A of a soft magnetic material with high momentum, the magnetization of which can be altered by being exposed to a magnetic field. With pole 36A positioned proximate or on magnetic portion 37A, magnetic portion 37A functions as a return pole for pole 36A of micro-speaker 3O. An electrically conducting coil 38A is positioned around pole 36A. Coil 38A is electrically connected to a circuit that provides electric current to coil 38A. Positioned within chamber 32B is a pole 36B of a soft magnetic material with high momentum, the magnetization of which can be altered by being exposed to a magnetic field. With pole 36B positioned proximate or on magnetic portion 37B, magnetic portion 37B functions as a return pole for pole 36B of micro-speaker 30. An electrically conducting coil 38B is positioned around pole 36B. Coil 3 8B is electrically connected to a circuit that provides electric current to coil 38B. Coils 38A, 38B may be electrically connected or may be electrically separate and controlled individually.

In use, an electrical current is applied to either or both coils 38A, 38B, which generates a magnetic field and polarizes (e.g., charges) the respective pole 36A, 36B and optionally the respective magnetic portion 37A, 37B. The total magnetic field from poles 36A, 36B and portions 37A, 37B produces an attraction or repelling force on magnetic material 35, driving magnetic material 35 toward and away from pole 36A and from pole 36B in an oscillating motion. Because the south end of magnetic material 35 is fixed in FIG. 3, the north end of magnetic material 35 oscillates. Diaphragm 34, connected to magnetic member 35, likewise oscillates at a frequency to produce sound waves. By having coils 38A, 38B separately controlled, the phase of the attractive/repelling force can be controlled by changing the current, thus controlling the oscillation of magnetic material 35 and the bandwidth and peak frequency of speaker 30.

Similar to micro-speaker 20 described above, the bandwidth and peak frequency of micro-speaker 30 can be affected by mechanical features of the speaker, e.g., the spring constants of non-magnetic material 33 and diaphragm 34, configuration of diaphragm 34, and configuration of magnetic member 35, and also by the current through coils 38A, 38B.

The current through coils 3 8A, 3 8B can be independently adjusted, during use of speaker 30, to modify the bandwidth and peak frequency of speaker 30. Adjusting the current through coils 3 8A, 3 8B, in essence, adjusts a magnetic spring constant affecting magnetic member 35.

FIG. 4 illustrates a multi-chambered micro-speaker 40 having a body 41 that forms the overall shape of micro-speaker 40, which in this embodiment, can also be generalized as two micro-speakers sharing one diaphragm. Body 41 includes one sidewall non-magnetic portion 43A and a second, non-sidewall non-magnetic portion 43B. Body 41 also includes a magnetic portion 47 that has a first portion 47A, a second portion 47B opposite first portion 47A and a third portion 47C that forms a sidewall of body 41. First portion 47A extends from sidewall non-magnetic portion 43A to third portion 47C, and second portion 47B also extends from sidewall non-magnetic portion 43A to third portion 47C. A first enclosed inner chamber 42A is defined by side wall non-magnetic portion 43A, first magnetic portion 47A, third magnetic portion 47C, non-sidewall non-magnetic member 43B, a diaphragm 44 and a magnetic member 45, which are connected together. Similarly, a second enclosed inner chamber 42B is defined by sidewall non-magnetic portion 43A, second magnetic portion 47B, third magnetic portion 47C, non-sidewall non-magnetic portion 43B, diaphragm 44 and magnetic member 45. Magnetic member 45 is fixedly attached to non-sidewall non-magnetic member 43B at a first end (at its south pole in FIG. 4) and to diagraph 44 at a second end (at its north pole in FIG. 4).

Positioned within chamber 42A is a pole 46A of a soft magnetic material with high momentum, the magnetization of which can be altered by being exposed to a magnetic field. With pole 46A positioned proximate or on magnetic portion 47A, magnetic portion 47A functions as a return pole for pole 46A of micro-speaker 40. An electrically conducting coil 48A is positioned around pole 46A. Coil 48A is electrically connected to a circuit that provides electric current to coil 48A. Positioned within chamber 42B is a pole 46B of a soft magnetic material with high momentum, the magnetization of which can be altered by being exposed to a magnetic field. With pole 46B positioned proximate or on magnetic portion 47B, magnetic portion 47B functions as a return pole for pole 46B of micro-speaker 40. An electrically conducting coil 48B is positioned around pole 46B. Coil 48B is electrically connected to a circuit that provides electric current to coil 48B. Coils 48A, 48B may be electrically connected or may be electrically separate and controlled individually.

In use, when an electrical current is applied to second coil 48B (and no current is applied to first coil 48A), magnetic member 45 is attracted to second pole 46B, regardless of the current direction. Similarly, when an electrical current is applied to first coil 48A (and no current is applied to second coil 48B), magnetic member 45 is attracted to first pole 46A, regardless of the current direction. Because the south end of magnetic material 45 is fixed to non-sidewall non-magnetic connection 43B in FIG. 4, the north end of magnetic material 45 oscillates.

Similar to micro-speaker 30 described above, the bandwidth and peak frequency of micro-speaker 40 can be affected by mechanical features of the speaker, e.g., the spring constants of non-magnetic material 43A, 43B and diaphragm 44, configuration of diaphragm 44, and configuration of magnetic member 45, and also by the current through coils 48A, 48B. The current through coils 48A, 48B can be independently adjusted, during use of speaker 40, to modify the bandwidth and peak frequency of speaker 40. Adjusting the current through coils 48A, 48B, in essence, adjusts a magnetic spring constant affecting magnetic member 45. Non-sidewall non-magnetic member 43B is present to affect (e.g., decrease) the spring constant at the south end of magnetic member 45, so that motion of magnetic member 45 and of diaphragm 44 can be better controlled by the magnetic forces from poles 46A, 46B via coils 48A, 48B. In some embodiments, non-sidewall non-magnetic connection 43B is not present, but rather, the south end of magnetic material 45 is fixed to magnetic portion 47C.

The micro magnetic devices of this disclosure (e.g., micro-speakers 20, 20A, 30, 40) can be described as a magnetic monopolar device, due to one end of the magnetic dipole member (e.g., magnetic member 25, 25A, 35, 45) being fixed to a non-magnetic portion and a sidewall, with the other end having the ability to oscillate, e.g., with the flexible diaphragm 24, 24A, 34, 44.

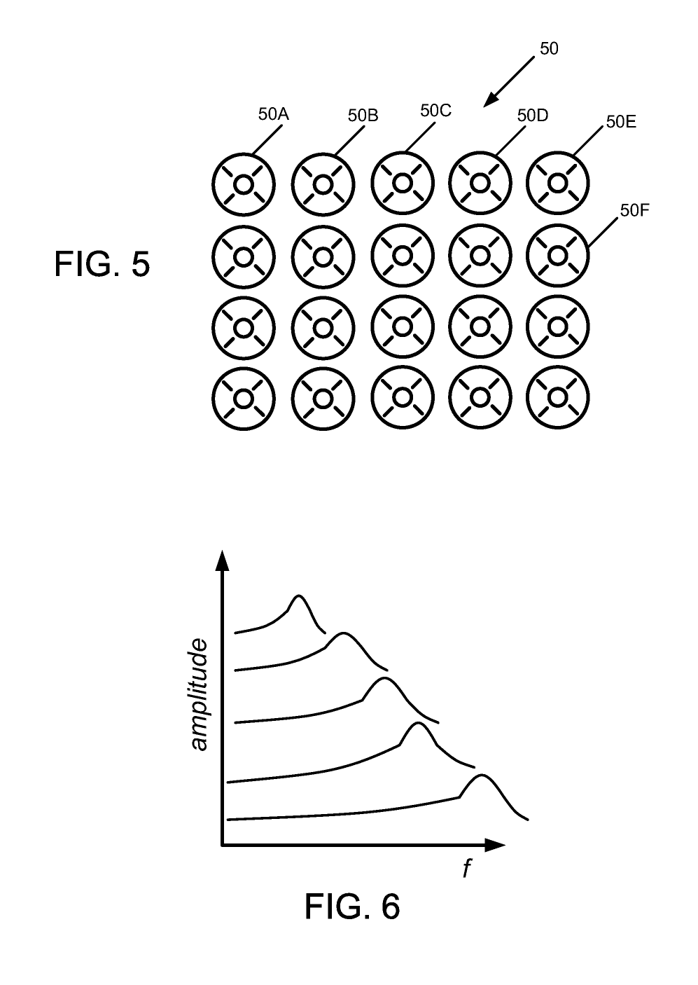

A plurality of micro magnetic devices (e.g., micro-speakers 20, 20A, 30, etc.) may be combined to form an array of micro magnetic devices on a single chip. FIG. 5 illustrates an array 50 of micro-speakers, in particular, twenty speakers that include speakers 50A, 50B, 50C, 50D, 50E and 50F, with additional micro-speakers illustrated but not identified. In array 50, each micro-speaker 50A, 50B, 50C, 50D, 50E, 50F, etc. has a predefined bandwidth; this predefined bandwidth may be based on its unique physical and mechanical structure or may be tunable during use (e.g., by adjusting the current that produces the oscillating diagraph). In some embodiments, each micro-speaker 50A, 50B, 50C, 50D, 50E, 50F, etc. has the same diaphragm thickness but a different diaphragm width, thus providing different frequency peaks. Together, micro-speakers 50A, 50B, 50C, 50D, 50E, 50F, etc. provide broad bandwidth coverage.

In embodiments having a speaker array composed of micro-speakers 40 of FIG. 4, the frequency range can be tuned by controlling the current in both coils 48A and 48B. The higher current makes the higher effective magnetic spring constant for coils 48A, 48B. The mechanical parameters including diaphragm thickness, width, and mass also affect the operating frequency.

FIG. 6 graphically illustrates multiple individual bandwidths, each from a single speaker, and their distribution over a broad frequency range. It provides a generic frequency distribution for five different speakers, which may differ in their membrane and magnetic member configuration (e.g., have a larger membrane), or which may differ in the amount of current being used to drive the membrane. With the micro magnetic devices of this invention, the total sound wave spatial distribution can be controlled at each individual unit (e.g., speaker 50A, 50B, etc. of FIG. 5) to obtain the desired frequency peak and frequency bandwidth with minimum power usage.

The micro magnetic devices of this disclosure are easy to optimize to the desired frequency bandwidth. As mentioned above, the peak frequency and the bandwidth are dependent on the geometry of the diaphragm, which can be readily designed and manufactured using micro magnetic actuator technology (e.g., thin film or MEMS techniques). Based on this technology, sound can be tuned or directed to the designated direction with higher acoustic power density. Additionally, the peak frequency and bandwidth can be tuned by adjusting the current through the speaker, which affects the oscillation of the sound producing diaphragm.

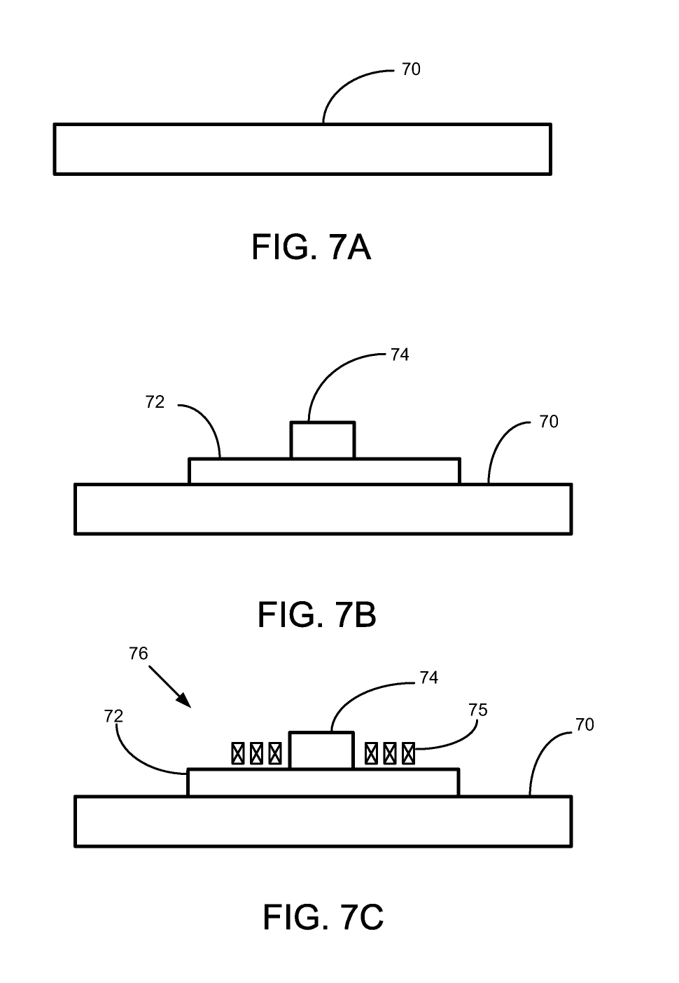

One general method of making a single chambered micro magnetic device, such as micro-speaker 20 of FIG. 2, is illustrated in FIGS. 7A-7C, 8A-8D, and 9A-9B.

In FIGS. 7A through 7C, a first portion of a micro-speaker is step-wise manufactured. A starting support 70 is illustrated in FIG. 7A; support 70 is a carrier or support surface for the eventual micro device, and is not illustrated in the illustration of speaker 20 in FIG. 2. In many embodiments, support 70 is an inert, dielectric material, such as silica. In FIG. 7B, applied onto support 70 is a layer of soft ferromagnetic material 72, which will form the eventual magnetic material portion (e.g., magnetic material portion 27 of micro-speaker 20). Soft ferromagnetic material 72 may be plated (e.g., electroplated), deposited (e.g., CVD, PVD, sputtered), or screen printed from a slurry of ferromagnetic particles in a binder material. Applied over soft ferromagnetic material 72 is another soft ferromagnetic material 74, which will form the eventual pole (e.g., pole 26 of micro-speaker 20). Soft ferromagnetic material 74 may be plated (e.g., electroplated), deposited (e.g., CVD, PVD, sputtered), or screen printed from a slurry of ferromagnetic particles in a binder material. Material 74 may be the same or different than material 72. In some embodiments, material 72 and material 74 may be applied in the same step rather than in sequential steps. An electrically conductive coil 75 is positioned around pole material 74 in FIG. 7C. Coil 75 may be previously produced and physically placed around pole material 74, or coil 75 may be fabricated (e.g., plated or deposited) around pole material 74. The result is first structure 76.

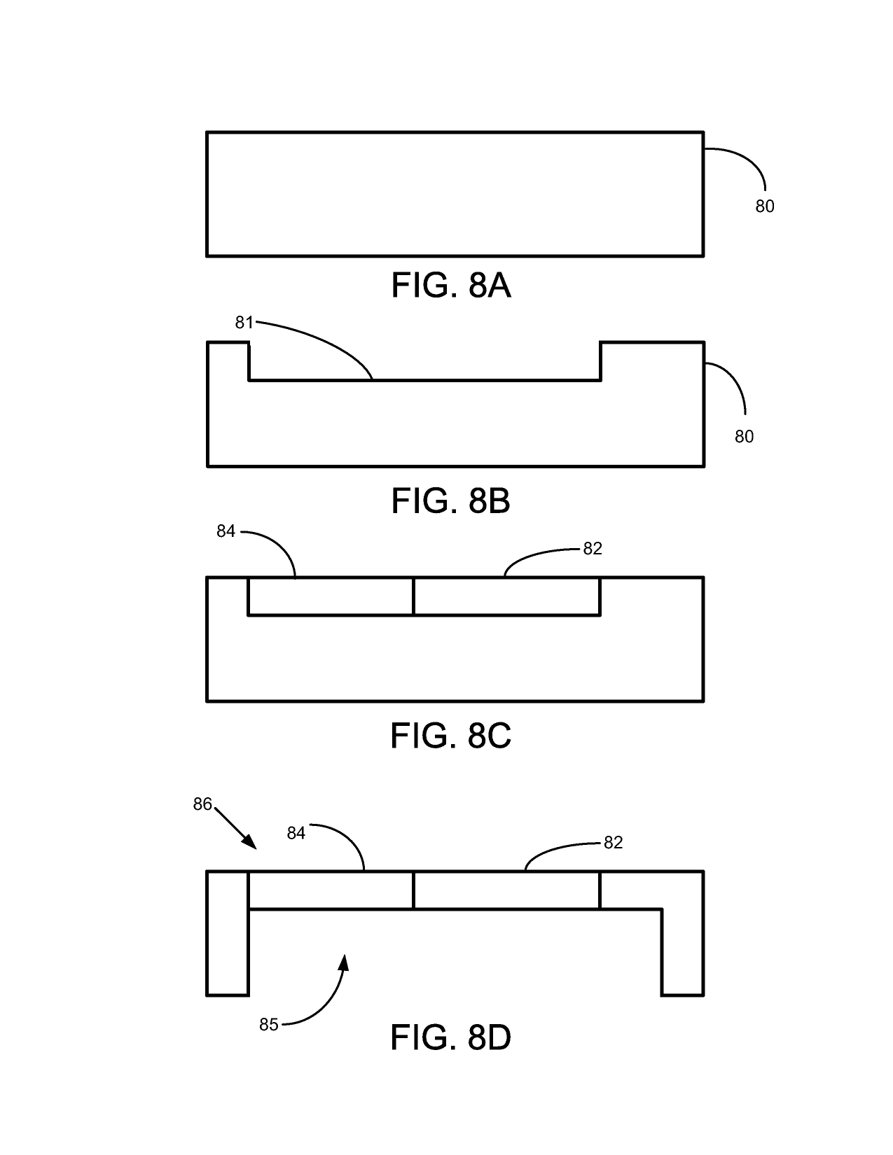

In FIGS. 8A through 8D, a second portion of a micro-speaker is step-wise manufactured. If referring to micro-speaker 20 of FIG. 2, this second portion is the top or upper portion of speaker 20. A starting non-magnetic material 80 is illustrated in FIG. 8A. In many embodiments, non-magnetic material 80 is silica. In FIG. 8B, a recess 81 is formed in non-magnetic material 80; in FIG. 8C, applied into recess 81 are a hard or permanent ferromagnetic material 82, which will form the eventual magnet of the speaker (e.g., magnetic member 25 of speaker 20), and a membrane material 84, which will form the eventual diaphragm of the speaker (e.g., diaphragm 24 of speaker 20). Hard ferromagnetic material 82 may be plated (e.g., electroplated), deposited (e.g., CVD, PVD, sputtered), or screen printed from a slurry of ferromagnetic particles in a binder material. In FIG. 8D, a cavity 85 is shown formed in support 80 that will form the eventual inner chamber of the speaker (e.g., chamber 22 of speaker 20 in FIG. 2). Support 80 may be etched away by conventional thin film etching processes to form cavity 85, or, substrate 80 may be built-up. The result is second portion 86.

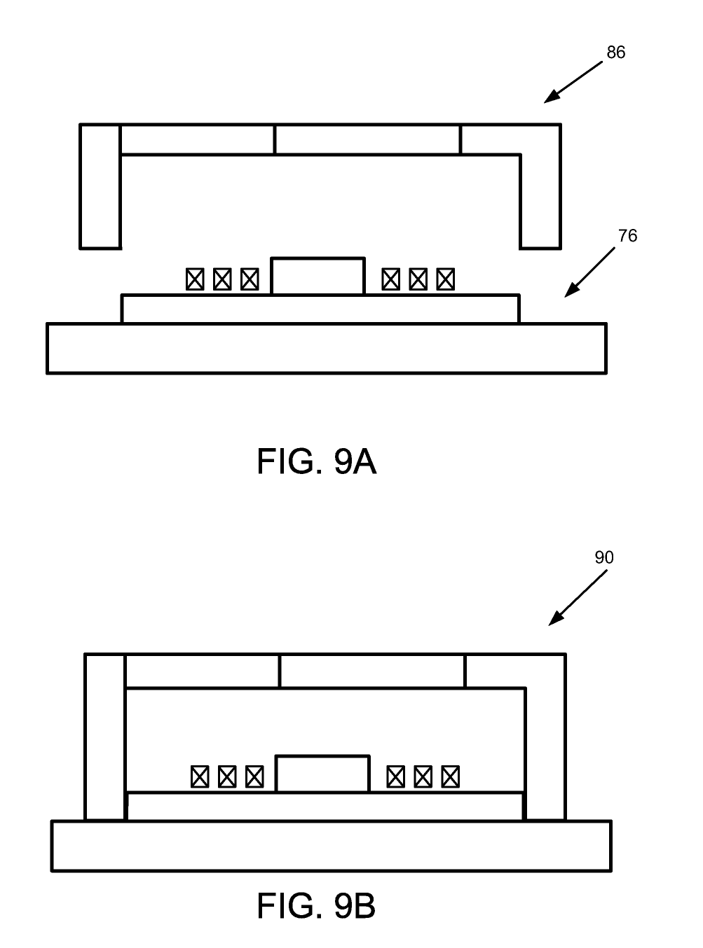

In FIG. 9A, first portion 76 from FIG. 7C is joined to second portion 86 from FIG. 8D. This may be done by wafer bonding, under the application of heat and/or pressure. In some embodiments, an adhesive or solder material may be used to facilitate the bonding. The resulting micro-speaker is illustrated in FIG. 9B as speaker 90, similar to micro-speaker 20 of FIG. 2.

Multiple-chamber speakers, such as micro-speakers 30, 40, could be made by similar methods, but, for example, joining three portions together. It is understood that the micro magnetic devices of this disclosure, whether single chamber or multi-chamber, could be made by any number of alternate methods.

Thus, embodiments of the MICRO MAGNETIC DEVICE WITH MAGNETIC SPRING are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

The use of numerical identifiers, such as “first”, “second”, etc. in the claims that follow is for purposes of identification and providing antecedent basis. Unless content clearly dictates otherwise, it should not be implied that a numerical identifier refers to the number of such elements required to be present in a device, system or apparatus. For example, if a device includes a first coil, it should not be implied that a second coil is required in that device.

What is claimed is:

1. A micro magnetic device comprising:
a body defining at least part of a first enclosed chamber, the body comprising a first sidewall and a second sidewall;
a first pole comprising a soft magnetic material within the first chamber;
a first electrically conductive coil positioned around the first pole;
a diaphragm connected to the first sidewall; and
a permanent dipole magnet connected to the second sidewall at a first end and to the diaphragm at a second end, the dipole magnet offset centrally from the pole.

2. The micro magnetic device of claim 1 wherein the first sidewall and the second sidewall comprise non-magnetic material.

3. The micro magnetic device of claim 2 wherein the first sidewall and the second sidewall comprise silicon.

4. The micro magnetic device of claim 1 wherein the diaphragm and the dipole magnet at least partially define the first enclosed chamber.

5. The micro magnetic device of claim 4 wherein the diaphragm is offset centrally from the first pole.

6. The micro magnetic device of claim 1 wherein the second sidewall comprises a beam extending therefrom, with the first end of the dipole magnetic connected to the beam.

7. The micro magnetic device of claim 1 wherein the body further defines at least a part of a second enclosed chamber, and the device further comprises a second pole comprising a soft magnetic material within the second chamber and a second electrically conductive coil positioned around the second pole, the diaphragm and the dipole magnet positioned between the first pole and the first coil and the second pole and the second coil.

8. The micro magnetic s device of claim 7 wherein the dipole magnet is not centrally positioned in relation to the second pole.

9. The micro magnetic device of claim 1 wherein the micro magnetic device is a micro magnetic speaker.

10. The micro magnetic device of claim 1 having a largest dimension of no greater than about 2 mm.

11. The micro magnetic device of claim 1 wherein the dipole magnet comprises iron, chromium, cobalt, nickel, platinum, vanadium, manganese, bismuth, or combinations thereof.

12. The micro magnetic device of claim 1 wherein the diaphragm comprises silicon.

13. A micro magnetic speaker comprising:
a first enclosed chamber having therein a first pole comprising a soft magnetic material and a first electrically conductive coil positioned around the first pole;
a second enclosed chamber having therein a second pole comprising a soft magnetic material and a second electrically conductive coil positioned around the second pole;
the first chamber and the second chamber sharing a first sidewall and a second sidewall;
a diaphragm connected to the first sidewall; and
a permanent dipole magnet connected to the second sidewall at a first end and to the diaphragm at a second end, the dipole magnet offset centrally from the pole.

14. The micro magnetic speaker of claim 13 wherein the second sidewall comprises a beam extending therefrom, with the first end of the dipole magnetic connected to the beam.

15. A micro magnetic speaker comprising:
a first enclosed chamber having therein a first pole comprising a soft magnetic material and a first electrically conductive coil positioned around the first pole;
a second enclosed chamber having therein a second pole comprising a soft magnetic material and a second electrically conductive coil positioned around the second pole; and
a diaphragm and a permanent dipole magnet extending between the first chamber and the second chamber and configured to oscillate between the first chamber and the second chamber based on a magnetic spring constant.

16. The micro magnetic speaker of claim 15 wherein the magnetic spring constant comprises a first magnetic spring constant and a second magnetic spring constant.

17. The micro magnetic speaker of claim 16 wherein the first magnetic spring constant is defined by a current through the first coil, and the second magnetic spring constant is defined by a current through the second coil.

18. The micro magnetic speaker of claim 15 wherein the dipole magnet is offset centrally from the pole.

19. The micro magnetic speaker of claim 15 wherein the first chamber and the second chamber share a first sidewall and a second sidewall, and the diaphragm is connected to the first sidewall and the permanent dipole magnet is connected to the second sidewall.

20. The micro magnetic speaker of claim 19 wherein the diaphragm and permanent dipole magnet are configured to oscillate between the first chamber and the second chamber based on a mechanical spring constant.
